(19) United States
(12) Patent Application Publication
(10) Pub. No.: US 2008/0235343 A1
(43) Pub. Date: Sep. 25, 2008

(54) SYSTEM FOR STATUS REPORTING

(75) Inventor: Tomasz F. WILK, Cary, NC (US)

Correspondence Address: SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 12/130,706

(22) Filed: May 30, 2008

Related U.S. Application Data
(63) Continuation of application No. 11/115,505, filed on Apr. 27, 2005.

(51) Int. Cl. G06F 15/16

(52) U.S. Cl. 709/206

(57) ABSTRACT

A system for status reporting. The system provides a plurality of status messages, and reports to at least two user groups at least two status messages of the plurality of status messages, wherein each of the at least two user groups receives a different status message.

### CROSS-REFERENCE TO RELATED APPLICATION

Under 35 USC §120 this application is a continuation application and claims the benefit of priority to U.S. patent application Ser. No. 11/115,505, filed Apr. 27, 2005, entitled “Method for Status Reporting,” which is incorporated herein by reference.

### FIELD OF THE INVENTION

The present invention relates to computer systems, and more particularly to a method and system for status reporting.

### BACKGROUND OF THE INVENTION

Instant messaging (IM) systems such as Sametime Connect or Windows Messenger are well known. Conventional IM systems report a user's status to all of the other users so that they know whether or not the user is available for IM.

A user database stores the current activity status for each user of the IM system. For example, if a user is connected to the IM system, the activity status would indicate “active” to the rest of the users. If the user is not connected, the activity status would indicate “not connected.” Some IM systems also indicate alternative means for contacting a user by stating whether the user is “available in-person,” “via telephone,” “via wireless device or wireless messaging device.” Such messages are generally broadcasted to everyone. A problem with conventional IM systems is that a user may be “online” (i.e. connected to the IM system) but may not want certain users to know.

Accordingly, what is needed is an improved system and method for status reporting. The system and method should be simple, cost effective, and capable of being easily adapted to existing technology. The present invention addresses such a need.

### SUMMARY OF THE INVENTION

A method and system for status reporting is disclosed. The method includes providing a plurality of status messages, and reporting to at least two user groups at least two status messages of the plurality of status message, wherein each of the at least two user groups receives a different status message.

According to the method and system disclosed herein, the present invention provides a user with more flexibility in status reporting. The present invention also enables a user to customize unique status messages for different users.

### BRIEF DESCRIPTION OF THE DRAWINGS

FIG. 1 is a block diagram of an instant messaging IM system in accordance with the present invention.

FIG. 2 is a block diagram illustrating a user, a first user group (labeled “Friends”), and a second user group (labeled “Others”), in accordance with the present invention.

The FIG. 3 is a flow chart showing a method for status reporting in accordance with the present invention.

FIG. 4 is a chart showing how the user can determine unique status messages for each group, in accordance with the present invention.

FIG. 5 is a screen shot showing how the user can select which specific users belong to each group, in accordance with the present invention.

### DETAILED DESCRIPTION OF THE INVENTION

The present invention relates to computer systems, and more particularly to a method and system for status reporting. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiment shown, but is to be accorded the widest scope consistent with the principles and features described herein.

A method and system in accordance with the present invention for status reporting are disclosed. The method and system enable a user to selectively report the user's status. The user can report one status message (e.g. “active”) to a select group of users and can report another status message (e.g. “away) to another group of users.

As a result, the method and system in accordance with the present invention provides the user with more flexibility in status reporting. The method and system in accordance with the present invention also enables the user to customize unique status messages for different users. To more particularly describe the features of the present invention, refer now to the following description in conjunction with the accompanying figures.

Although the present invention disclosed herein is described in the context of instant messaging systems, the present invention may apply to other types of messaging systems, and still remain within the spirit and scope of the present invention.

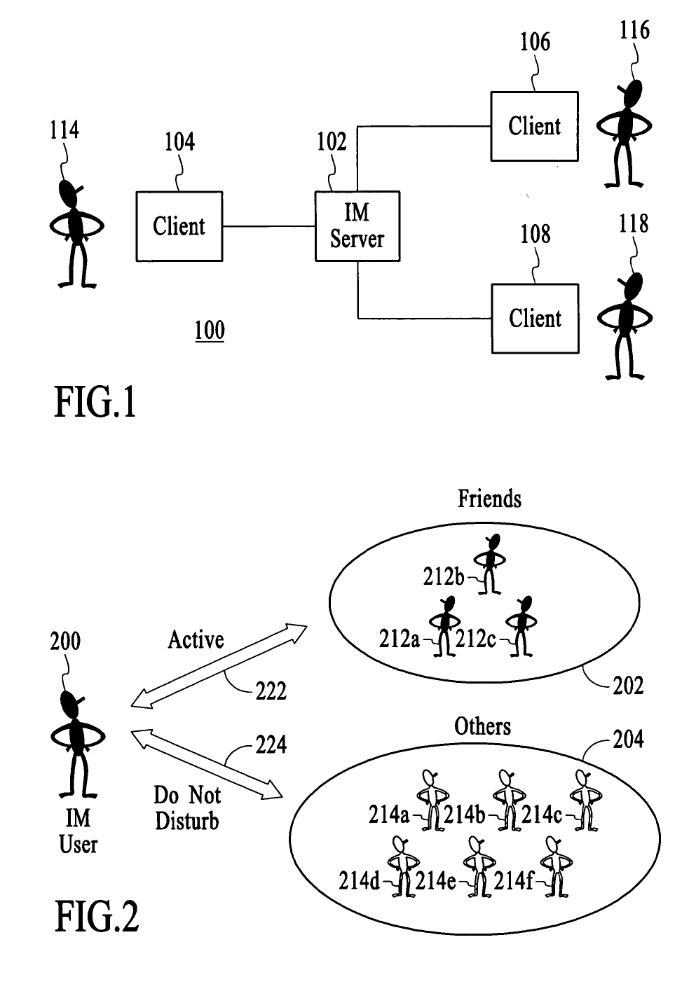

FIG. 1 is a block diagram of an instant messaging IM system 100 in accordance with the present invention. The IM system 100 includes an IM server 102 that connects multiple clients 104, 106, and 108, of respective users 114, 116, and 118. For ease of illustration, only three users are shown. The actual number of users will vary. In operation, generally, the users 114-118 use their respective clients 104-108 to send instant messages to each other. In accordance with the present invention, each user can selectively report his/her user status to the other users.

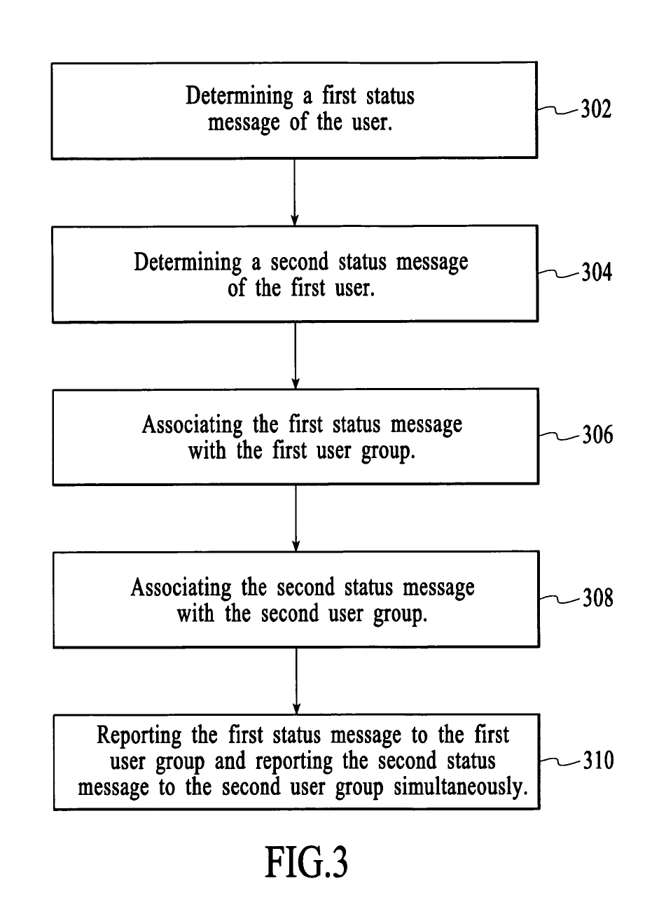

FIG. 2 is a block diagram of illustrating a user 200, a first user group 202 (labeled “Friends”), and a second user group 204 (labeled “Others”), in accordance with the present invention. The user 200 can label the first and second user groups 202 and 204 anything the user 200 wants to (e.g. “work peers”, “managers”). The first user group 202 includes one or more users 212a, 212b, and 212c, and the second user group 204 includes one or more users 214a, 214b, 214c, 214d, 214e, and 214f. FIG. 2 also shows status messages 222 (“Active”) and 222 (“Do not disturb”). The FIG. 3 is a flow chart showing a method for status reporting in accordance with the present invention. Referring to both FIGS. 2 and 3 together, the process begins in a step 302 when a first status message of the user 200 is determined. A selection of status messages (e.g. “Active,” “Do not disturb,” “Not connected”) is available for the user 200 to select. In this example, the first status message is the status message 222 “Active.” Next, in a step 304, a second status message of the user 200 is determined. Here, the second status message is the status message 224 “Do not disturb.” Next, in a step 306, the first status message 222 is associated with the first user group 202. Next, in a step 308, the second status message 224 is associated with the second user group 204. Software at the IM server 102 (FIG. 1) and/or at the client 104 enables the associations. Next, in a step 310, the first status message is reported to the first user group and the second status message is reported to the second user group substantially simultaneously. Software at the IM server 102 (FIG. 1) and/or at the client 104 performs the reporting of the first and second status messages.

As can be seen, each of the user groups 202 and 204 receives a unique status message. As such, when a user 200 does not want to be disturbed, the user 200 may choose to appear busy to one group and appear to be active/available to another group.

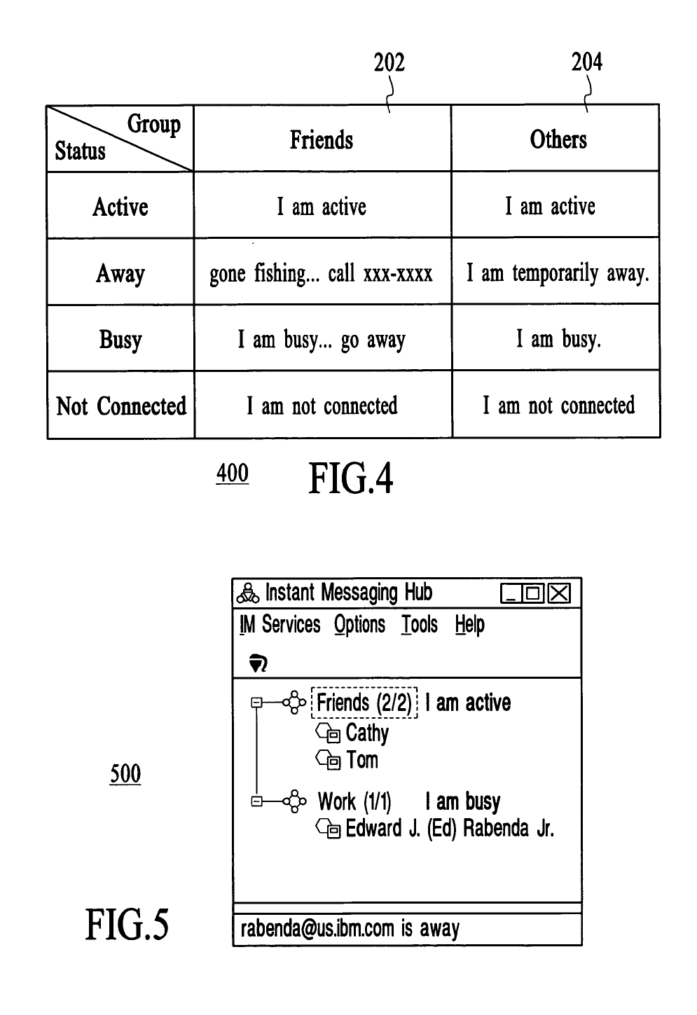

FIG. 4 is a chart showing how the user 200 can determine unique status messages for each group, in accordance with the present invention. Referring to both FIGS. 2 and 4 together, the user 200 may create a list of different status messages such as “Active,” “Away,” “Busy,” “Not Connected,” etc. These status messages can be the default messages that the user 200 can independently associated with each of the user groups 202 and 204.

In accordance with the present invention, the user 200 can also customize status messages. For example, instead of indicating “Away,” the user 200 can indicate the (“Friends”) group 202, “I've gone fishing. Please call (xxx) xxx-xxxx if you want to reach me by cell phone.” The user 200 can indicate to the (“Others”) group 204, “I am temporarily away.”

FIG. 5 is a screen shot showing how the user 200 can select which specific users belong to each group, in accordance with the present invention. For example, the user 200 may want to receive instant messages from the users “Cathy” and “Tom”. The user 200, however, may not want to receive instant messages from the user “Edward.” Accordingly, the user 200 selects/associates the users “Cathy” and “Tom” who are friends to the “Friends” group, which receives a status message indicating “I am active.” The user 200 selects/associates the user “Edward” with the “Work” group, which receives a status message indicating “I am busy.”

There is preferably an option available for the user to associate with a particular group all users whom have not yet been associated with a group (e.g. “everyone else”). The IM system keeps track of which users are associated with each group and what status message is associated with each group.

According to the system and method disclosed herein, the present invention provides numerous benefits. For example, it provides a user with more flexibility in status reporting. Embodiments of the present invention also enable a user to customize unique status messages for different users.

A method and system in accordance with the present invention for status reporting has been disclosed. The method and system enable a user to selectively report the user's status. The user can report one status message (e.g. “active”) to a select group of users and can report another status message (e.g. “away) to another group of users. As a result, the method and system in accordance with the present invention provides the user with more flexibility in status reporting. The method and system in accordance with the present invention also enables the user to customize unique status messages for different users.

The present invention has been described in accordance with the embodiments shown. One of ordinary skill in the art will readily recognize that there could be variations to the embodiments, and that any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

What is claimed is:

1. A system for status reporting, the system comprising:
a server; and
a client coupled to the server for:
providing a plurality of status messages, wherein the plurality of status messages comprises a first status message of a first user and a second status message of the first user, wherein the first status message and the second status message each indicates one of “active,” “busy,” “away,” and “not connected”;
enabling the first user to customize the first status message and the second status message by modifying the wording of the first status message and the second status message;
enabling the first user to customize at least one status message of the first status message and the second status message to include a user-customized reason for a given status message;
enabling the first user to customize at least one status message of the first status message and the second status message to include a phone number for reaching the first user;
associating the first status message with a first user group;
associating the second status message with a second user group;
displaying the first user group, the first status message, the second user group, and the second status message, wherein the first status message is displayed next to the first user group, and wherein the second status message is displayed next to the second group; and
reporting to at least two user groups at least two status messages of the plurality of status messages, wherein each of the at least two user groups receives a different status message, and wherein the at least two status messages of the plurality of status messages are reported to the at least two user groups simultaneously.

2. A computer-readable medium containing program instructions for status reporting, the program instructions which when executed by a computer system cause the computer system to execute a method comprising:
in an instant messaging system, providing a plurality of status messages, wherein the plurality of status messages comprises a first status message of a first user and a second status message of the first user, wherein the first status message and the second status message each indicates one of “active,” “busy,” “away,” and “not connected”;
enabling the first user to customize the first status message and the second status message by modifying the wording of the first status message and the second status message;
enabling the first user to customize at least one status message of the first status message and the second status message to include a user-customized reason for a given status message;
enabling the first user to customize at least one status message of the first status message and the second status message to include a phone number for reaching the first user;
associating the first status message with a first user group;
associating the second status message with a second user group;
displaying the first user group, the first status message, the second user group, and the second status message, wherein the first status message is displayed next to the first user group, and wherein the second status message is displayed next to the second group; and
reporting to at least two user groups at least two status messages of the plurality of status messages, wherein each of the at least two user groups receives a different status message, and wherein the at least two status messages of the plurality of status messages are reported to the at least two user groups simultaneously.
